(19) United States
(12) Patent Application Publication
(10) Pub. No.: US 2025/0252531 A1
(43) Pub. Date: Aug. 7, 2025

(54) SYSTEM AND METHOD FOR DEPTH DENSIFICATION AND CONFIDENCE MAP GENERATION

(71) Applicant: Meta Platforms Technologies, LLC, Menlo Park, CA (US)

(72) Inventors: Jinhui Xiong, Redwood City, CA (US); Rakesh Ranjan, Mountain View, CA (US); Zijian He, Palo Alto, CA (US); Wei Ye, Mountain View, CA (US); Jialiang Wang, Mountain View, CA (US); Shanghsuan Tsai, Sunnyvale, CA (US); Shuochen Su, Bellevue, WA (US); Yue Zhao, Foster City, CA (US)

(21) Appl. No.: 18/430,201

(22) Filed: Feb. 1, 2024

(51) Int. Cl. G06T 3/4053; G06T 5/60

(52) U.S. Cl. CPC G06T 3/4053; G06T 5/60; G06T 2207/10028; G06T 2207/20016

(57) ABSTRACT

A method for generating an output depth map is provided. The method is performed by a computing device. When the computing device executes this method, it receives input image data of a scene, and receives an input depth map of the scene, the input depth map having an input resolution. Using a machine-learning model, the device generates multiple kernels for upsampling the input depth map to produce an output depth map with a higher resolution than the one of the input depth map. These kernels are generated based on the input image data and the input depth map, with each kernel consisting of multiple weights. Subsequently, the computing device applies these kernels to the input depth map to generate the output depth map. Each kernel is applied to a portion of the input depth map to generate a depth value for a pixel of the output depth map.

### TECHNICAL FIELD

This disclosure pertains to the estimation of high-resolution depth maps, focusing on the generation of high-resolution depth maps from low-resolution depth maps and image data.

### BACKGROUND

Accurately determining high-resolution depth maps is crucial for a wide range of applications, including virtual reality, 3D modeling, 3D video stabilization, augmented reality (AR), special video effects, and preparing videos for virtual reality (VR) viewing. However, the task of constructing high-resolution depth maps from low-resolution depth maps presents a significant challenge due to several inherent complexities. The fundamental issue lies in the limited data available in low-resolution depth maps. These maps typically provide only sparse or low-resolution depth information, resulting in a lack of a sufficient number of data points to accurately capture the intricate details of a scene. Furthermore, when utilizing image data to aid in the construction of high-resolution depth maps, the process is further complicated by the necessity to establish correspondences between depth values and their corresponding image elements. Additionally, scenes that contain flat or textureless surfaces, such as featureless walls, tend to be particularly challenging for depth map construction, as there may be a lack of distinctive features that can be matched between images, leading to ambiguity and inaccuracy in depth estimation. Additionally, scenes with low illumination further amplify the reconstruction difficulties. Overall, the generation of high-resolution depth maps necessitates sophisticated techniques that can overcome these challenges and determine high-resolution depth maps from the available data.

Previous algorithms aimed at densely reconstructing scenes often struggled with the challenges mentioned above. For instance, algorithms that relied on Structure from Motion (SFM) and Multi-view Stereo (MVS) faced limitations in terms of accuracy. MVS algorithms encountered difficulties when attempting to accurately reconstruct scenes with textureless surfaces or scenes illuminated with low light. Even when MVS algorithms succeed, their reconstructions typically contain numerous gaps and noise. Learning-based algorithms, on the other hand, are better equipped to address these issues. Instead of relying on point matching across frames and geometric triangulation, they leverage learned priors from diverse training datasets. This capability enables them to handle many of the aforementioned challenging scenarios.

Consequently, there is a need for an improved algorithm capable of producing accurate high-resolution depth maps based on available image data and low-resolution depth maps. Additionally, there is a demand for an algorithm that can assess the confidence level in the quality of the resulting high-resolution depth maps.

### SUMMARY OF PARTICULAR EMBODIMENTS

Embodiments described herein relate to a method for determining high resolution output depth map based in low-resolution depth map and image data.

In particular non-limiting embodiments, the method includes receiving input image data of a scene, receiving an input depth map of the scene, the input depth map having an input resolution, and generating, using a machine-learning model, a plurality of kernels for upsampling the input depth map in order to generate an output depth map having an output resolution higher than the input resolution. The plurality of kernels are generated based on the input image data and the input depth map, wherein each kernel from the plurality of kernels includes a plurality of weights. Further the method includes applying the plurality of kernels to the input depth map to generate the output depth map, wherein each kernel is applied to a portion of the input depth map to generate a depth value for a pixel of the output depth map.

In particular non-limiting embodiments, the method further includes determining, based on the plurality of weights corresponding to cach kernel from the plurality of kernels, a confidence map for the output depth map.

In particular non-limiting embodiments, the confidence map is a map of standard deviations for weights corresponding to each kernel from the plurality of kernels.

In particular non-limiting embodiments, a number of kernels of the plurality of kernels matches a number of pixels in the output depth map.

In particular non-limiting embodiments, the input depth map is determined using one of a time-of-flight sensor or one or more stereo matching sensors.

In particular non-limiting embodiments, the machine-learning model is trained using low-resolution training input depth maps and corresponding high-resolution training true depth maps.

In particular non-limiting embodiments, the machine-learning model is trained using a loss function constructed as a difference between a transformed true depth map and a corresponding transformed output depth map, and wherein the transformation includes one of a sine transform, a cosine transform, or a Fourier transform.

In particular non-limiting embodiments, the machine-learning model is trained using a loss function constructed as a difference between a transformed gradient of a true depth map and a transformed gradient of a corresponding output depth map, and wherein the transformation includes one of a sine transform, a cosine transform, or a Fourier transform.

In particular non-limiting embodiments, the input depth map of the scene is a first input depth map, the method further comprising receiving a second input depth map of the scene, and wherein the generating of the plurality of kernels includes upsampling the first input depth map and the second input depth map, the plurality of kernels being generated based on the input image data the first input depth map and the second input depth map.

In particular non-limiting embodiments, the computing device includes a depth sensor for capturing input depth maps, and wherein the first input depth map is captured by the depth sensor at a first position of the computing device within an environment, and wherein the second input depth map is captured by the depth sensor at a second position within the environment, the second position being different from the first position.

In particular non-limiting embodiments, the input image data is first input image data, the method further includes receiving second input image data of the scene, and wherein plurality of kernels being generated based on the first input image data, the second input image data, the first input depth map and the second input depth map.

In particular non-limiting embodiments, the computing device includes a camera for capturing input image data, wherein the first input image data is captured by the camera at the first position, and the second input image data is captured by the camera at the second position.

In particular non-limiting embodiments, the computing device includes one or more motion sensors, for determining a change in position from the first position to the second position.

In particular non-limiting embodiments, the input image data is a first input image data, the input depth map is a first input depth map, the plurality of kernels is a first plurality of kernels, the plurality of weights is a first plurality of weights, and the output depth map is a first output depth map. Further the method includes determining, based on the first plurality of weights corresponding to cach kernel from the first plurality of kernels, a first confidence map for the first output depth map, and evaluating, based on a selected measure function, acceptability of the first confidence map. When the first confidence map is determined to be not acceptable, the method includes receiving second input image data of the scene, receiving a second input depth map of the scene, the second input depth map having a second input resolution, and generating, using the machine-learning model, a second plurality of kernels for upsampling the second input depth map in order to generate a second output depth map having a second output resolution higher than the second input resolution. The second plurality of kernels are generated based on the second input image data and the second input depth map, wherein each kernel from the second plurality of kernels includes a second plurality of weights. Further, the method includes applying the second plurality of kernels to the second input depth map to generate the second output depth map, wherein each kernel is applied to a portion of the second input depth map to generate a depth value for a pixel of the second output depth map.

In particular non-limiting embodiments, when the first confidence map is determined to be not acceptable, based on the second plurality of weights corresponding to each kernel from the second plurality of kernels, the method includes determining a second confidence map for the second output depth map.

In particular non-limiting embodiments, computing device includes a camera for capturing input image data, and wherein the first input image data is captured by the camera using first camera settings and the second input image data is captured by the camera using second camera settings different from the first camera settings.

In particular non-limiting embodiments one or more computer-readable non-transitory storage media embodying software is provided. The media is operable when executed to receive input image data of a scene, receive an input depth map of the scene, the input depth map having an input resolution, and generate, using a machine-learning model, a plurality of kernels for upsampling the input depth map in order to generate an output depth map having an output resolution higher than the input resolution. The plurality of kernels are generated based on the input image data and the input depth map, wherein each kernel from the plurality of kernels includes a plurality of weights. Further, the media is operable to apply the plurality of kernels to the input depth map to generate the output depth map, wherein cach kernel is applied to a portion of the input depth map to generate a depth value for a pixel of the output depth map.

In particular non-limiting embodiments, the software is further operable when executed to determine, based on the plurality of weights corresponding to each kernel from the plurality of kernels, a confidence map for the output depth map.

In particular non-limiting embodiments, a system having one or more processors and one or more computer-readable non-transitory storage media coupled to one or more of the processors is provided. The system includes instructions operable when executed by one or more of the processors to cause the system to receive input image data of a scene, receive an input depth map of the scene, the input depth map having an input resolution, and generate, using a machine-learning model, a plurality of kernels for upsampling the input depth map in order to generate an output depth map having an output resolution higher than the input resolution. The plurality of kernels are generated based on the input image data and the input depth map, wherein cach kernel from the plurality of kernels includes a plurality of weights. Further, system includes instructions operable when executed by one or more of the processors to cause the system to apply the plurality of kernels to the input depth map to generate the output depth map, wherein cach kernel is applied to a portion of the input depth map to generate a depth value for a pixel of the output depth map.

In particular non-limiting embodiments, the one or more processors are further operable when executing the instructions to determine, based on the plurality of weights corresponding to cach kernel from the plurality of kernels, a confidence map for the output depth map.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, and a system, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 is an example system for determining high-resolution depth maps from image data and low-resolution depth maps, in accordance with disclosed embodiments.

FIG. 2 is an example embodiment of a system for determining high-resolution depth maps from image data and low-resolution depth maps, in accordance with disclosed embodiments.

FIGS. 3A is an example block diagram for obtaining a set of output kernels and a confidence map, in accordance with disclosed embodiments.

FIGS. 3B is an example block diagram for obtaining a high-resolution output depth map, in accordance with disclosed embodiments.

FIG. 4 is an example block diagram for training a machine learning model used for obtaining a high-resolution output depth map, in accordance with disclosed embodiments.

FIG. 5 is an example method for evaluating a loss function based on a transformed true depth map and a transformed output depth map, in accordance with disclosed embodiments.

FIG. 6 is an example method for obtaining high-resolution output depth maps, in accordance with disclosed embodiments.

### DESCRIPTION OF EXAMPLE EMBODIMENTS

Embodiments described herein relate to systems and methods for determining high-resolution depth maps based on captured image data and low-resolution depth maps. In various embodiments, the image data and data associated with low-resolution depth maps can be captured by suitable sensors. For example, image data can be captured by cameras such as visible cameras, infrared cameras, ultraviolet cameras, and the like, while low-resolution depth maps may be determined using a depth sensors such as stereo depth sensors, structured light depth sensors, time-of-flight (ToF) sensors, and any other suitable technique for measuring the depth of an physical environment.

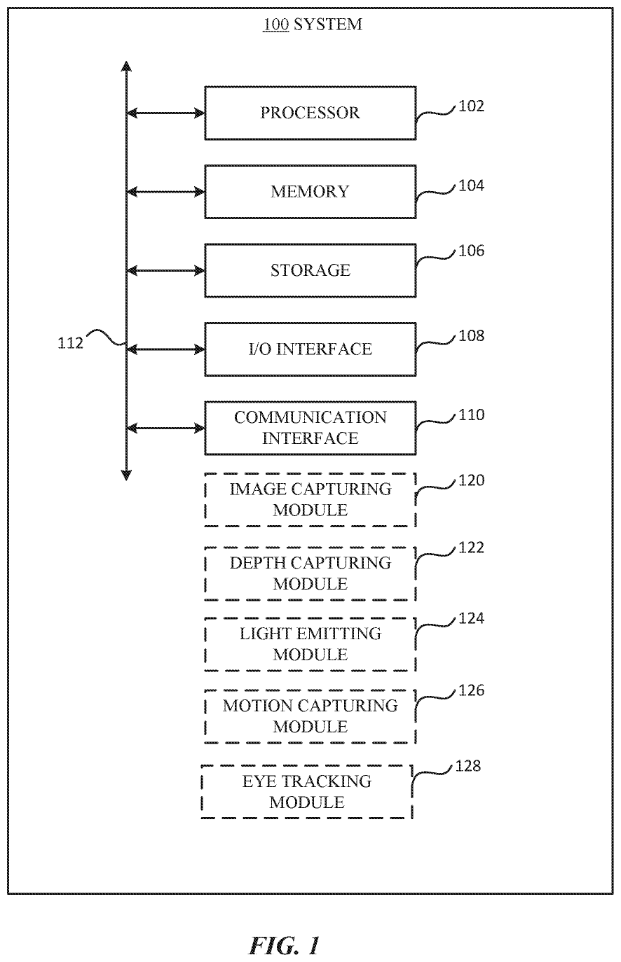

FIG. 1 illustrates an example system 100 for determining high-resolution depth maps based on captured image data and low-resolution depth maps. In various embodiments, system 100 may perform one or more steps of one or more methods described or illustrated herein. System 100 may include software instructions for performing one or more steps of the methods described or illustrated herein. Further, various other instructions may also provide various other functionalities of system 100, as described or illustrated herein. Various embodiments include one or more portions of system 100. System 100 may include one or more computing systems. Herein, reference to a computer system may encompass a computing device, and vice versa, where appropriate. Moreover, reference to a computer system may encompass one or more computer systems, where appropriate.

This disclosure contemplates any suitable number of computer systems that can be included in system 100. This disclosure contemplates system 100 taking any suitable physical form. As example and not by way of limitation, system 100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, a game console or a combination of two or more of these. Where appropriate, system 100 may include one or more computer systems; be unitary or distributed; span multiple locations; span multiple machines; span multiple data centers; or reside in a cloud, which may include one or more cloud components in one or more networks. Where appropriate, system 100 may perform without substantial spatial or temporal limitation one or more steps of one or more methods described or illustrated herein. As an example and not by way of limitation, system 100 may perform in real time or in batch mode one or more steps of one or more methods described or illustrated herein. System 100 may perform at different times or at different locations one or more steps of one or more methods described or illustrated herein, where appropriate.

In various embodiments, system 100 includes a processor 102, memory 104, storage 106, an input/output (I/O) interface 108, a communication interface 110, and a bus 112. Further, optionally, system 100 may include an image capturing module 120, a depth capturing module 122, a light emitting module 124, a motion capturing module 126, and an eye tracking module 128. Although this disclosure describes and illustrates a particular system 100 having a particular number of particular components in a particular arrangement, this disclosure contemplates any suitable system having any suitable number of any suitable components in any suitable arrangement.

In various embodiments, processor 102 includes hardware for executing instructions, such as those making up a computer program. As an example and not by way of limitation, to execute instructions, processor 102 may retrieve (or fetch) the instructions from an internal register, an internal cache, memory 104, or storage 106; decode and execute them; and then write one or more results to an internal register, an internal cache, memory 104, or storage 106. In some embodiments, processor 102 may include one or more internal caches for data, instructions, or addresses. This disclosure contemplates processor 102 including any suitable number of any suitable internal caches, where appropriate. As an example and not by way of limitation, processor 102 may include one or more instruction caches, one or more data caches, and one or more translation lookaside buffers (TLBs). Instructions in the instruction caches may be copies of instructions in memory 104 or storage 106, and the instruction caches may speed up retrieval of those instructions by processor 102. Data in the data caches may be copies of data in memory 104 or storage 106 for instructions executing at processor 102 to operate on; the results of previous instructions executed at processor 102 for access by subsequent instructions executing at processor 102 or for writing to memory 104 or storage 106; or other suitable data. The data caches may speed up read or write operations by processor 102. The TLBs may speed up virtual-address translation for processor 102. In particular embodiments, processor 102 may include one or more internal registers for data, instructions, or addresses. This disclosure contemplates processor 102 including any suitable number of any suitable internal registers, where appropriate. Where appropriate, processor 102 may include one or more arithmetic logic units (ALUs); be a multi-core processor; or include one or more processors 102. Although this disclosure describes and illustrates a particular processor, this disclosure contemplates any suitable processor.

In particular embodiments, memory 104 includes main memory for storing instructions for processor 102 to execute or data for processor 102 to operate on. As an example and not by way of limitation, system 100 may load instructions from storage 106 or another source (such as, for example, another system 100) to memory 104. Processor 102 may then load the instructions from memory 104 to an internal register or internal cache. To execute the instructions, processor 102 may retrieve the instructions from the internal register or internal cache and decode them. During or after execution of the instructions, processor 102 may write one or more results (which may be intermediate or final results) to the internal register or internal cache. Processor 102 may then write one or more of those results to memory 104. In particular embodiments, processor 102 executes only instructions in one or more internal registers or internal caches or in memory 104 (as opposed to storage 106 or elsewhere) and operates only on data in one or more internal registers or internal caches or in memory 104 (as opposed to storage 106 or elsewhere). One or more memory buses (which may cach include an address bus and a data bus) may couple processor 102 to memory 104. Bus 112 may include one or more memory buses, as described below. In particular embodiments, one or more memory management units (MMUs) reside between processor 102 and memory 104 and facilitate accesses to memory 104 requested by processor 102. In particular embodiments, memory 104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi- ported RAM. This disclosure contemplates any suitable RAM. Memory 104 may include one or more memories 104, where appropriate. Although this disclosure describes and illustrates particular memory, this disclosure contemplates any suitable memory.

In particular embodiments, storage 106 includes mass storage for data or instructions. As an example and not by way of limitation, storage 106 may include a hard disk drive (HDD), a floppy disk drive, flash memory, an optical disc, a magneto-optical disc, magnetic tape, or a Universal Serial Bus (USB) drive or a combination of two or more of these. Storage 106 may include removable or non-removable (or fixed) media, where appropriate. Storage 106 may be internal or external to system 100, where appropriate. In particular embodiments, storage 106 is non-volatile, solid-state memory. In particular embodiments, storage 106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 106 taking any suitable physical form. Storage 106 may include one or more storage control units facilitating communication between processor 102 and storage 106, where appropriate. Where appropriate, storage 106 may include one or more storages 106. Although this disclosure describes and illustrates particular storage, this disclosure contemplates any suitable storage.

In particular embodiments, I/O interface 108 includes hardware, software, or both, providing one or more interfaces for communication between system 100 and one or more I/O devices. System 100 may include one or more of these I/O devices, where appropriate. One or more of these I/O devices may enable communication between a person and system 100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 108 for them. Where appropriate, I/O interface 108 may include one or more device or software drivers enabling processor 102 to drive one or more of these I/O devices. I/O interface 108 may include one or more I/O interfaces 108, where appropriate. Although this disclosure describes and illustrates a particular I/O interface, this disclosure contemplates any suitable I/O interface.

In particular embodiments, communication interface 110 includes hardware, software, or both providing one or more interfaces for communication (such as, for example, packet-based communication) between system 100 and any other devices interfacing with the system 100 via one or more networks. As an example and not by way of limitation, communication interface 110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 110 for it. As an example and not by way of limitation, system 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, system 100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. System 100 may include any suitable communication interface 110 for any of these networks, where appropriate. Communication interface 110 may include one or more communication interfaces 110, where appropriate. Although this disclosure describes and illustrates a particular communication interface, this disclosure contemplates any suitable communication interface.

In particular embodiments, bus 112 includes hardware, software, or both coupling components of system 100 to each other. As an example and not by way of limitation, bus 112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 112 may include one or more buses 112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

In various embodiments, system 100 may include image capturing module 120 that includes one or more image capturing devices. These devices may consist of a wide range of suitable cameras, including those designed for capturing visible, infrared, or ultraviolet light. Camera options may feature Complementary Metal-Oxide-Semiconductor (CMOS) or Charge-Coupled Device (CCD) sensors, which come in various sizes and resolutions. These sizes include full-frame sensors, APS-C sensors, compact sensors, and the like, with resolutions ranging from a few to several tens of megapixels, or even exceeding 50 megapixels. Additionally, the image capturing devices may be equipped with various lens systems, such as zoom, wide-angle, fish-eye, telephoto, macro, tilt-shift, or any other suitable lenses. Image capturing module 120 may also include additional components like a flashlight (e.g., an LED flashlight), an independent power source (e.g., a battery) for operating the image capturing devices, and a local data storage device for on-site image data storage.

In certain implementations, image capturing module 120 may include two or more image capturing devices. For example, the first image capturing device may be used for capturing a first image of a scene and the second image capturing device for capturing a second image of the same scene. These two image capturing devices can be positioned at a predetermined distance from each other. For instance, in the context of a VR headset, the first image capturing device may be located near one eye of the user, while the second image capturing device may be positioned near the other eye of the user. The distance between these two devices is typically approximately the same as the distance between the user's eyes, typically within a range of about 55 millimeters to about 80 millimeters.

In some implementations, each image capturing device may encompass one or more cameras, often referred to as sensors. For example, an image capturing device within image capturing module 120 could include a primary sensor, such as a high-resolution sensor (e.g., a 30-60 megapixel sensor) with a digital sensor array of pixel sensors. Each pixel sensor may be designed with a sufficiently large size (e.g., a few microns) to capture an adequate amount of light from the camera's aperture. Additionally, the image capturing device may include an ultra-wide sensor, a telephoto sensor, or any other suitable sensor, such as infrared or ultraviolet sensors.

In some scenarios, image capturing devices within image capturing module 120, or the cameras within such devices, can be designed for mobility. These devices may be capable of rotating about one or more axes, moving laterally in various directions, or a combination of these movements. In certain situations, when image capturing module 120 comprises both a first and a second image capturing device, the first device may rotate to simulate the left eye's movement of the user, while the second device rotates to mimic the motion of the right eye. This synchronized movement enables these devices to capture images of an object within the user's field of view, i.e., the object onto which the user's eyes are verging. To clarify, the term “verging” in this context refers to the coordinated movement of both eyes to align their visual axes on a specific object or point in space. This alignment is crucial for binocular vision, which allows the user to perceive depth and experience a three-dimensional view of the world. The degree of vergence, or convergence, varies depending on the distance to the observed object.

Such movement of image capturing devices can be achieved through a variety of mechanical mechanisms, such as gears, springs, bearings, rotary cylinders, wheels, gimbals, and more. These mechanisms are actuated by appropriate motors, including electrical rotational or linear actuators, solenoids, stepper motors, servo motors, hydraulic cylinders, pneumatic actuators, piezoelectric actuators, shape memory alloy-based actuators, acoustic actuators, muscle-like actuators, and the like.

The eye tracking module 128 may be specifically designed to monitor the movement, including rotation, of the user's eyes, and may be responsible for identifying the object upon which the user's gaze converges. This system incorporates cameras that are tailored to detect eye motion, thus, enabling the determination of the visual axes for both the left and right eyes. Various devices can be employed for eye tracking, including video-based tracking (e.g., cameras), infrared trackers, or any other suitable eye tracking sensors (e.g., electrooculography sensors). Once the object within a scene is identified, the image capture devices can be configured to adjust their focal length to focus on a region of the scene surrounding the recognized object.

By way of example and not as a limitation, as previously described, image capturing module 120 may be a component of system 100, which, in turn, may be part of a VR headset. In such an implementation, or in similar scenarios, the image capturing devices are positioned closely to one another. In other implementations, the image capturing devices may be located remotely from the user, such as being installed on a remote vehicle like an autonomous vehicle, being part of a surveillance system, and the like.

Additionally, system 100 may include depth capturing module 122 configured to determine a depth map of a scene which is observed by the user. The depth map includes information about distances between eyes of a user and objects within an environment of the user. Depth capturing module 122 is configured to determine depth maps of a scene observed by the user. Depth capturing module 122 may use any suitable devices for determining depth maps of the scene. For instance, depth capturing module 122 may utilize Light Detection and Ranging devices (LiDARs), stereo cameras (e.g., stereo cameras use two or more cameras to capture images of a scene from slightly different angles, and determine the depth maps from the disparity between the captured images), structured light scanners (e.g., devices that project a structured light pattern, such as a grid or stripes, onto an object or environment, and based on a distortion of the structured pattern calculate the depth map), structured light LiDARs, time-of-flight (ToF) cameras, ultrasonic sensors, or any other suitable sensors (e.g., moving cameras utilizing photogrammetry).

Furthermore, in some embodiments, system 100 may include light emitting module 124 configured to enhance the illumination of various objects within the scene observed by the user. Light emitting module 124 may include one or more light-emitting devices, which can encompass a wide range of options for emitting light to illuminate objects, including but not limited to light-emitting diodes (LEDs), infrared light emitters (such as infrared LEDs), fluorescent light sources, compact fluorescent light sources, incandescent light sources, halogen light sources, lasers, organic LEDs, black light sources, ultraviolet light sources, and the like.

In some instances, these light sources may incorporate appropriate optical elements, such as lenses, prisms, mirrors, and similar components, to direct light towards a specific object of interest within the scene. For instance, in certain implementations, system 100 may determine which object requires increased illumination, and that object can be effectively illuminated by directing light from a light source to the target object using suitable optical means, which may include one or more lenses.

As a possible scenario, when image data or depth data of an object within the scene necessitates additional resolution or requires reacquisition for improved object resolution, system 100 can be configured to guide the light emitted by a light source specifically to that object.

It should be noted that light emitting module 124 may have multiple light emitting sources, with at least some of the sources having different light emitting characteristics. For example, the light emitting sources can include a first light emitting source for emitting a focused light and a second light emitting source for emitting a diffused light. In some cases, a first light emitting source may be an LED and a second light emitting source may be a laser. Additionally, in some implementations, a first light emitting source may emit at a visible light wavelength, while a second light emitting source may emit at a wavelength that is not visible to a human eye (e.g., at an infrared wavelength).

In some cases, light emitting module 124 (or at least some of light emitting sources of the light emitting module 124) may be movable. These sources may be capable of rotating about one or more axes, moving laterally in various directions, or a combination of these movements. In certain situations, at least some of the light emitting sources may rotate to simulate a movement of an eye of a user. When two focused light emitting sources are present, one focused light emitting source can rotate to mimic the left eye's movement of the user, while the second focused light emitting source may rotate to mimic the motion of the right eye. This synchronized movement enables these sources to focus on an object within the user's field of view.

Such movement of light emitting sources can be achieved through a variety of mechanical mechanisms, such as gears, springs, bearings, rotary cylinders, wheels, gimbals, and more. These mechanisms are actuated by appropriate motors, including electrical rotational or linear actuators, solenoids, stepper motors, servo motors, hydraulic cylinders, pneumatic actuators, piezoelectric actuators, shape memory alloy-based actuators, acoustic actuators, muscle-like actuators, and the like.

By way of example, similar to image capturing module 120, and not as a limitation, light emitting module 124 may be a component of system 100, which, in turn, may be part of a VR headset. In such an implementation, or in similar scenarios, the light emitting sources of light emitting module 124 are positioned closely to one another. In other implementations, the light emitting sources may be located remotely from the user, such as being installed on a remote vehicle like an autonomous vehicle, being part of a surveillance system, and the like.

Additionally, in some embodiments, system 100 may incorporate a motion capturing module 126. This module is designed to capture the movements of the image capturing module 120, depth capturing module 122, and light emitting module 124. In scenarios where image capturing module 120, depth capturing module 122, and light emitting module 124 are integrated into a VR headset, motion capturing module 126 can be configured to record both translational and rotational displacements of the VR headset. This includes instances where the user rotates or moves their head.

The data on these displacements serves multiple purposes. It can be utilized to recalibrate the depth map captured by depth capturing module 122, to reacquire a new depth map using depth capturing module 122, or to obtain new image data using image capturing module 120. Furthermore, the motion of the user's head can indicate a shift in the user's focus to a new object within the observed scene. This change in focus may, in turn, trigger further movements and adjustments in the image capturing devices of image capturing module 120 and the light emitting sources of the light emitting module 124.

In certain scenarios, the motion capturing module 126 may not only be configured to detect movements of the user's head but also to monitor the movements of one or more objects within the user's environment. When such object movements are detected, system 100 may determine that new image data needs to be captured by the image capturing module 120 or that a new depth map needs to be generated using the depth capturing module 122. For instance, if an object within the scene surrounding the user (e.g., a pet) moves within that scene, new image and depth data may be required.

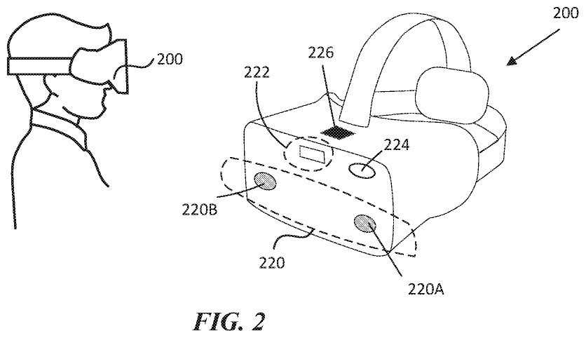

In various embodiments, system 100 may be implemented as a VR headset. For instance, FIG. 2 presents an example embodiment of a system 200, which serves as an example implementation of system 100. System 200 comprises an image capturing module 220, housing a first image capturing device 220A and a second image capturing device 220B, a depth capturing module 222, a light emitting module 224, and a motion capturing module 226.

As described above, depth capturing module 122 may use any suitable devices such as stereo cameras, ToF sensors or other suitable sensors for obtaining a depth map. In many cases, however, stereo cameras may face difficulties when capturing depth maps for scenes with flat walls because they rely on the principle of triangulation to calculate depth. Triangulation involves comparing the slightly different perspectives of two cameras to determine the depth of objects in the scene. When applied to flat and textureless surfaces like walls, several challenges arise, such as lack of feature points, ambiguity, and baseline limitations, among others. The lack of feature points is due to flat and textureless surfaces providing few distinctive features that stereo cameras can match between the left and right images. Without these matching features, it becomes challenging to establish correspondences and calculate depth accurately. The ambiguity is due to multiple depth solutions possible for the same set of image features, when such features include flat surfaces or uniformly textured surfaces, and baseline limitation is due to a parallax between stereo cameras being sufficiently small to accurately calculate depth for flat walls that are sufficiently distant from the stereo cameras (e.g., when distance between the stereo cameras and the flat wall is significantly larger than the distance between stereo cameras). Further limitations of stereo cameras for obtaining accurate depth maps include low light image capturing and determining depth of flat walls/surfaces in vicinity of objects occluding the flat walls/surfaces.

To address these challenges, specialized algorithms and techniques can be used, such as structured light projection, time-of-flight (ToF) cameras, or LiDAR (Light Detection and Ranging) sensors, which provide alternative methods for capturing depth information in scenes, including those with flat and textureless surfaces. These technologies are often more robust in such scenarios and can complement the limitations of stereo cameras. The ToF cameras, in particular, are helpful in obtaining depth maps, however, with limited resolution. Therefore, various embodiments described herein are focused on algorithms based on machine learning for obtaining accurate high-resolution depth maps based on the initial low-resolution depth maps of a scene captured by ToF cameras and images of the scene.

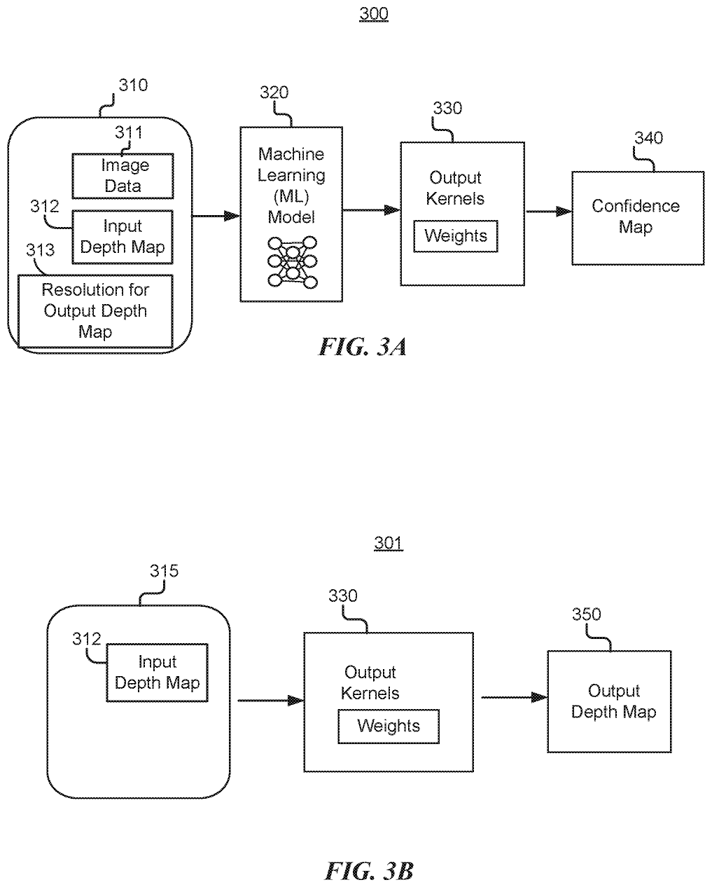

FIG. 3A illustrates a block diagram 300 depicting the use of a machine learning model 320 with input data 310 to determine output kernels 330 along with a confidence map 340, indicating the confidence level in the accuracy of each pixel within a high-resolution output depth map. FIG. 3B shows how the output kernels 330 are used to determine a high-resolution output depth map 350 based on input data 315.

As the initial step in generating high-resolution output depth map 350, machine learning model 320 takes input data 310, which includes input image data 311-images collected by the image capturing module 120, low-resolution input depth map 312-typically collected by ToF sensors of depth capturing module 122, and a desired resolution for output depth map 313, and produces a set of output kernels 330. The number of output kernels 330 corresponds to the number of pixels within high-resolution output depth map 350 specified by desired resolution for output depth map 313. In various embodiments, a kernel from the set of output kernels 330 can be represented by a weight matrix. For instance, in some implementations, the kernel may take the form of a three-by-three weight matrix, a four-by-four matrix, or any other suitable matrix size.

In various embodiments, weights of a kernel may be used to determine a standard deviation for that kernel. For example, if the kernel has N weights wᵢ a square of a standard deviation may be determined as τ²=Σ_{i=1 . . . N}(wᵢ−w̅)/N, with w̅ representing the average of the weights. The calculated standard deviation can be plotted for each pixel, corresponding to each kernel within the set of output kernels 330, resulting in the creation of confidence map 340. Confidence map 340 serves to indicate that when a kernel exhibits weights with a notably high standard deviation, the confidence level regarding the depth of the pixel corresponding to that kernel may be correspondingly reduced. In an illustrative implementation, confidence map 340 could be depicted as a contour map, an elevation map, a color-coded heatmap, or in any other similar representation. On occasion, confidence map 340 can be overlaid onto an image of a scene to provide additional visual cues for areas with low confidence in depth values.

The kernel from output kernels 330 is configured to convolve with a kernel-specific region of low-resolution input depth map 312. This convolution process generates at least one pixel within the high-resolution depth map. The use of kernels is important for incorporation of depth-related information obtained from image data 311 and low-resolution depth map 312. Essentially, these kernels from output kernels 330 act as special interpolation operators, mapping a region from low-resolution input depth map 312 to a pixel within high-resolution output depth map 350. As shown in FIG. 3B, the block diagram 301 illustrates how the kernel is designed to convolve with a specific segment of the low-resolution input depth map 312 from input data 315 to calculate a depth value for a particular pixel in high-resolution output depth map 350 that corresponds to that specific kernel.

It's important to mention that diagrams 300 and 301 are merely illustrative, and various modifications to these diagrams are feasible. For instance, the input data 310 might encompass multiple low-resolution depth maps of a scene. Specifically, a first low-resolution depth map could be sampled at one set of array points (e.g., like the array points 232), and a second low-resolution depth map might be sampled at a separate set of array points, with at least some of these array points differing from those in the first set. Moreover, in some situations, the first low-resolution depth map may be obtained when the user is in one location, while the second low-resolution depth map is acquired when the user is in a different location. For example, in cases where a depth capturing module is integrated into a VR headset, the user's head movements can lead to the time-dependent acquisition of low-resolution depth maps from distinct locations.

In some cases, a motion capturing module (e.g., motion capturing module 126) can contribute to enhancing the accuracy of the low-resolution depth maps. For instance, the initial low-resolution depth map and the user's head displacement can be utilized to forecast the second low-resolution depth map. This forecasted map can then be compared to the actual captured second low-resolution depth map to assess the reliability of the latter. In certain scenarios, the predicted second low-resolution depth map and the observed second low-resolution depth map can be integrated, such as through averaging, to enhance the overall quality of the second low-resolution depth map.

In certain scenarios where multiple ToF sensors are employed to gather depth information, the first low-resolution depth map can be acquired by one ToF sensor, while a second ToF sensor captures the second low-resolution depth map. Furthermore, in cases where other sensors are integrated, such as those utilizing structured light projection, LiDARs, and similar technologies, these sensors can collaboratively operate with one or more ToF sensors to obtain additional low-resolution depth maps.

It should be noted that image data 311 may include several images captured by suitable image capturing devices of an image capturing module. For example, the image data may include a first image taken using a first camera settings (e.g., monochromatic setting) and a second image taken using a second camera setting (e.g., hi ISO setting for low light condition). These images may be used together to further improve accuracy of output kernels 330 generated by machine learning model 320. Additionally, or alternatively, images may be taken by more than one image capturing devices at slightly different locations (e.g., by using stereo cameras).

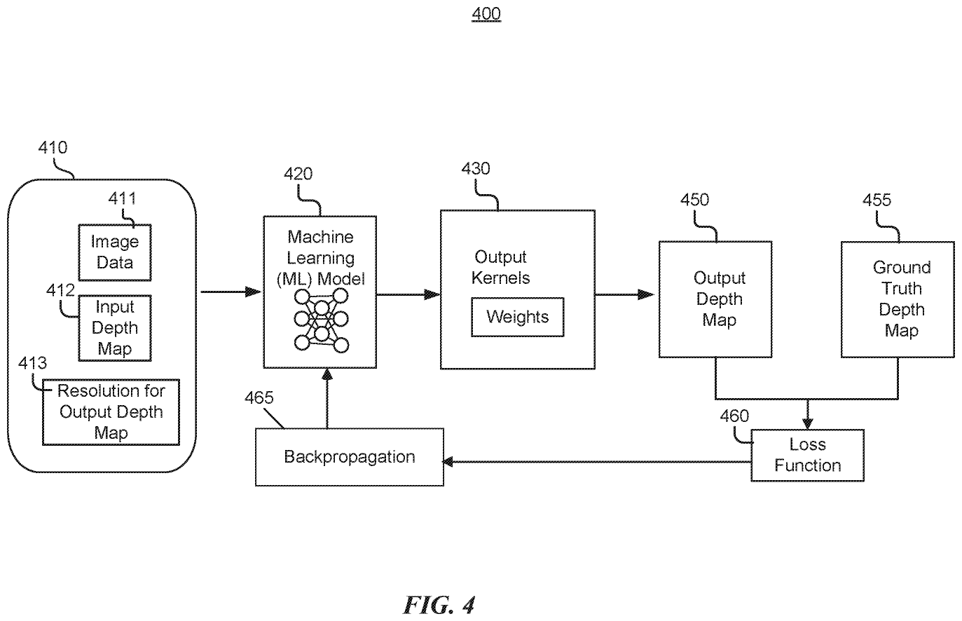

FIG. 4 presents a block diagram 400 illustrating the process of training a machine learning model 420, which can be either similar or the same in structure and function as machine learning model 320. In various embodiments, the training data includes an input data 410, which includes image data 411, low-resolution depth map 412, and a requested resolution for output depth map 413, as well as the high-resolution ground truth depth map 455, which needs to be matched by the high-resolution output depth map 450. In some cases, the low-resolution depth map 412 may be obtained by downsampling the high-resolution ground truth depth map 455.

In various embodiments, machine learning model 420 may be a deep neural network model such as convolutional neural network (CNN), or any other suitable model. In some cases, several machine learning approaches may be combined to form machine learning model 420. For example, CNN and support vector machines (SVM) models may be combined. Moreover, machine learning model 420 may encompass techniques like Random Forests and Decision Trees, K-Nearest Neighbor (K-NN) models, and similar methods. In some cases, Generative Adversarial Networks (GANs) and Variational Autoencoders (VAEs) can also be utilized.

The machine learning model 420 is trained to match the high-resolution output depth map 450 with the high-resolution ground truth depth map 455. During the training, the machine learning model 420 learns to extract features and patterns from the input low-resolution depth map with assistance of high-resolution images of a scene. This is done by applying convolutional layers to process the low-resolution depth map 412 and image data 411. The training is accomplished by computing a loss function 460 defined to measure the difference between the high-resolution output depth map 450 and the ground truth high-resolution depth map 455. Common loss functions can include computations like Mean Squared Error (MSE), Peak Signal-to-Noise Ratio (PSNR), Structural Similarity Index (SSIM), perceptual loss, or other suitable methods. After calculating the loss function 460, the training of machine learning model 420 includes adjusting parameters of machine learning model 420 (e.g., neural network weights) via backpropagation 465, a well-established technique in the field of machine learning.

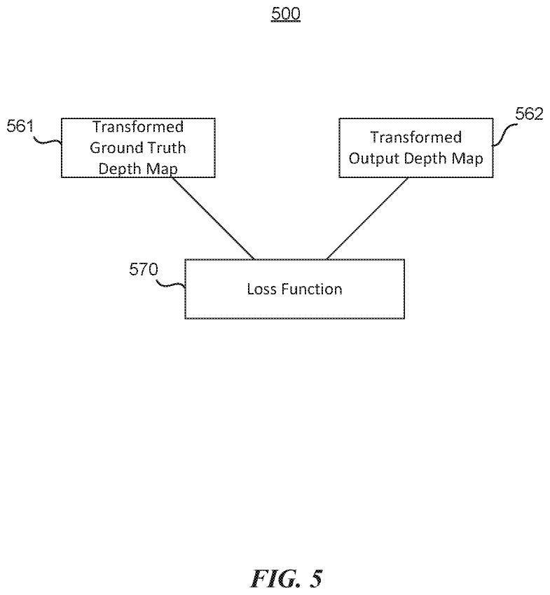

In certain embodiments, the loss function may be determined by using transformed high-resolution ground truth and high-resolution output depth maps. For instance, FIG. 5 illustrates a block diagram 500 for calculating loss function 570 through the use of transformed ground truth depth map 561 and transformed output depth map 562. Transformed ground truth depth map 561 can be obtained by applying a suitable transformation to the original ground truth depth map (e.g., ground truth depth map 455, as depicted in FIG. 4). This transformation could involve a sinc transform, a cosine transform, a Fourier transform, or any other appropriate method, such as a wavelet transform. Similarly, the transformed output depth map 562 may also be derived using similar transformations, including sine, cosine, Fourier transforms, or other suitable methods. After these transformations are applied, the loss function 570 can be computed using methods such as MSE, PSNR, SSIM, perceptual loss, or similar techniques.

In some cases, the loss function may be constructed as a difference between a transformed ground truth depth map and a corresponding transformed output depth map, and wherein the transformation includes one of a sine transform, a cosine transform, or a Fourier transform. Alternatively, in some cases, the loss function may be constructed as a difference between a transformed gradient of a ground truth depth map and a transformed gradient of a corresponding output depth map, and wherein the transformation includes one of a sine transform, a cosine transform, or a Fourier transform.

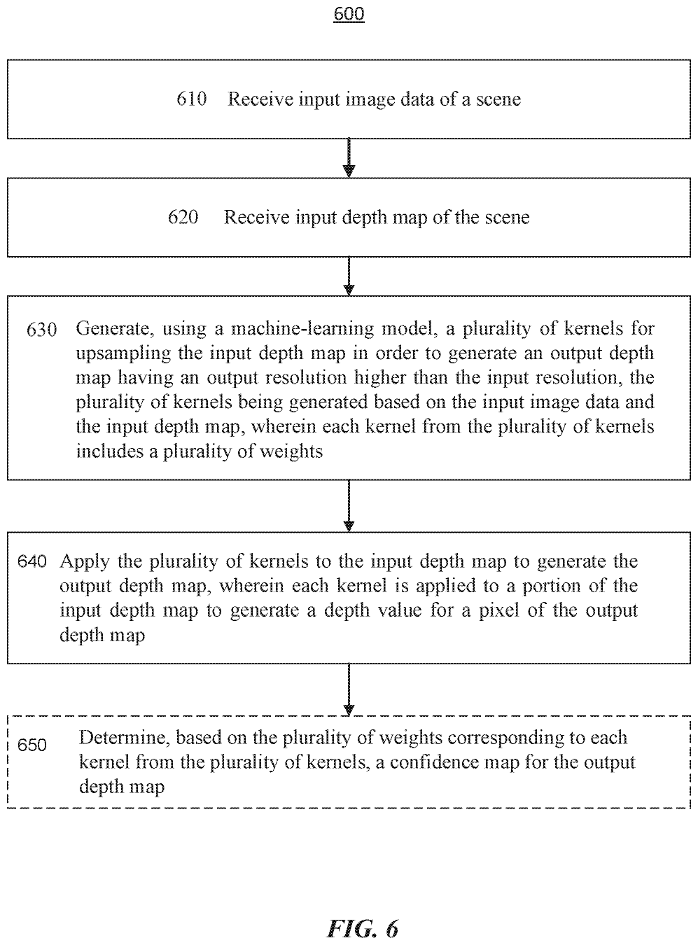

In various embodiments, system 100 is configured to perform operations of a method for obtaining a high-resolution depth map of a scene. FIG. 6 illustrates an example method 600 for obtaining a high-resolution depth map of a scene in accordance with particular embodiments. In particular, the method 600 illustrates steps performed by a processor 102 of system 100 discussed herein. Method 600 may begin at step 610 where a machine learning model is configured to receive input image data of a scene. The machine learning model may be either similar or the same in structure and function as machine learning model 320 or machine learning model 420. The input image data may be the same as input image data 311 or 411, as discussed herein. For example, the input image data may include one or more images of a scene obtained using one or more cameras.

At step 620, the machine learning model is configured to receive a low-resolution input depth map, herein, the low-resolution is also referred to as the input resolution. The low-resolution input depth map may be similar to the low-resolution input depth map 312 or 412, as discussed herein.

At step 630, the method 600 includes generating, using the machine-learning model, a plurality of kernels for upsampling the input depth map in order to generate an output depth map having an output resolution higher than the input resolution. The plurality of kernels are generated based on the input image data and the input depth map, wherein each kernel from the plurality of kernels includes a plurality of weights. The plurality of kernels may be similar to or the same as the set of output kernels 330 or 430 as described herein. Similar to previous discussion as related to FIGS. 3A, 3B, and 4, the plurality of kernels contain depth-related information about the scene based on the scene low-resolution depth map and the one or more high-resolution images of the scene. The plurality of kernels may represent a set of matrices with each matrix tailored to obtain a depth value for a pixel in the high-resolution output depth map, by convolving with a region of a low-resolution depth map.

Method 600 may conclude with step 640 of applying the plurality of kernels to the input depth map to generate the output depth map, wherein cach kernel is applied to a portion of the input depth map to generate a depth value for a pixel of the output depth map.

Alternatively, following step 640, method 600 may include an optional additional step 650 of determining, based on the plurality of weights corresponding to each kernel from the plurality of kernels, a confidence map for the output depth map. As earlier described in relation to FIG. 3A, the confidence map may consist of standard deviations, with each standard deviation computed for the weights of each kernel from the plurality of kernels.

It should be noted that method 600 is merely illustrative and other steps may be added or modified resulting in a method that is a variation of method 600. For example, image data obtained by the machine learning model may be first processed (e.g., some features of objects within images may be extracted) prior to providing the images to the machine learning model. For example, edge detection may be performed prior to providing images to the machine learning model and information about the edges may be provided to the machine learning model. In some cases, various step of method 600 may be repeated. For example, all the steps of the method 600 may be repeated for multiple images and multiple low-resolution depth maps.

In some embodiments, the input depth map of the scene may be a first input depth map. A variation of method 600 may further include receiving a second input depth map of the scene. Further, the generating of the plurality of kernels may include upsampling the first input depth map and the second input depth map, and generating the plurality of kernels based on the input image data the first input depth map and the second input depth map.

Similarly, in some cases, the image data may be first image data collected by an image capturing module, and in addition to receiving the second input depth map of the scene, a variation of method 600 may further include receiving second input image data of the scene, as well as generating the plurality of kernels based on the first input image data, the second input image data, the first input depth map and the second input depth map.

As described earlier, low-resolution depth maps may be obtained using a depth sensor such as time-of-flight sensor for capturing input depth maps. When several input depth maps are used, a first input depth map may be captured by the depth sensor at a first position of the computing device that includes system 100 within an environment, and a second input depth map may be captured by the depth sensor at a second position within the environment, the second position being different from the first position.

It is important to highlight that the confidence map obtained through method 600 can be employed in a feedback loop to enhance the accuracy of the output depth map generated by the method. For instance, a variant of method 600 may involve executing steps 610 to 650, and additionally evaluating, based on a selected measure function (or otherwise referred to as an evaluation metric), acceptability of the first confidence map. The measure function can take various forms. For example, it may be determined as the minimum confidence value or the average confidence value across the entire confidence map. Alternatively, regions with low confidence values within the map could undergo local averaging to determine localized average confidence values, and a minimum of local average confidence values can be used as the value returned by the measure function. Various other measure functions can be utilized as well. For example, confidence values might be assessed in regions deemed critical, such as those around specific objects within the scene, including objects that the user is focusing on or areas within the scene undergoing changes due to object movements, fluctuations in lighting conditions, and similar factors. The minimum value of such confidence values can be selected as the measure function.

In several scenarios, if a measure function indicates unacceptable confidence in the high-resolution depth map, which could be the case when the measure function assessing confidence levels falls below an acceptable threshold, the modified version of method 600 may involve repeating steps 610 to 650 using new input image data and a new input depth map of the scene. The new input image data may be collected from a different location than the previous data, with different camera settings, or under varied lighting conditions (e.g., using flash illumination). Similarly, the new low-resolution input depth map may be obtained differently from the previous one, involving a different location, distinct array points, or the utilization of additional sensors (e.g., structured-light projection sensors).

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

What is claimed is:

1. A method comprising, by a computing device:
receiving input image data of a scene;
receiving an input depth map of the scene, the input depth map having an input resolution;
generating, using a machine-learning model, a plurality of kernels for upsampling the input depth map in order to generate an output depth map having an output resolution higher than the input resolution, the plurality of kernels being generated based on the input image data and the input depth map, wherein each kernel from the plurality of kernels includes a plurality of weights; and
applying the plurality of kernels to the input depth map to generate the output depth map, wherein each kernel is applied to a portion of the input depth map to generate a depth value for a pixel of the output depth map.

2. The method of claim 1, further comprising determining, based on the plurality of weights corresponding to each kernel from the plurality of kernels, a confidence map for the output depth map.

3. The method of claim 2, wherein the confidence map is a map of standard deviations for weights corresponding to each kernel from the plurality of kernels.

4. The method of claim 1, wherein a number of kernels of the plurality of kernels matches a number of pixels in the output depth map.

5. The method of claim 1, wherein the input depth map is determined using one of a time-of-flight sensor or one or more stereo matching sensors.

6. The method of claim 1, wherein the machine-learning model is trained using low-resolution training input depth maps and corresponding high-resolution training ground truth depth maps.

7. The method of claim 6, wherein the machine-learning model is trained using a loss function constructed as a difference between a transformed ground truth depth map and a corresponding transformed output depth map, and wherein the transformation includes one of a sine transform, a cosine transform, or a Fourier transform.

8. The method of claim 6, wherein the machine-learning model is trained using a loss function constructed as a difference between a transformed gradient of a ground truth depth map and a transformed gradient of a corresponding output depth map, and wherein the transformation includes one of a sine transform, a cosine transform, or a Fourier transform.

9. The method of claim 1, wherein the input depth map of the scene is a first input depth map, the method further comprising receiving a second input depth map of the scene, and wherein the generating of the plurality of kernels includes upsampling the first input depth map and the second input depth map, the plurality of kernels being generated based on the input image data the first input depth map and the second input depth map.

10. The method of claim 9, wherein the computing device includes a depth sensor for capturing input depth maps, and wherein the first input depth map is captured by the depth sensor at a first position of the computing device within an environment, and wherein the second input depth map is captured by the depth sensor at a second position within the environment, the second position being different from the first position.

11. The method of claim 10, wherein the input image data is first input image data, the method further comprising receiving second input image data of the scene, and wherein plurality of kernels being generated based on the first input image data, the second input image data, the first input depth map and the second input depth map.

12. The method of claim 11, wherein the computing device includes a camera for capturing input image data, wherein the first input image data is captured by the camera at the first position, and the second input image data is captured by the camera at the second position.

13. The method of claim 12, wherein the computing device includes one or more motion sensors, for determining a change in position from the first position to the second position.

14. The method of claim 1, wherein the input image data is a first input image data, the input depth map is a first input depth map, the plurality of kernels is a first plurality of kernels, the plurality of weights is a first plurality of weights, and the output depth map is a first output depth map; the method further comprising:
determining, based on the first plurality of weights corresponding to each kernel from the first plurality of kernels, a first confidence map for the first output depth map;
evaluating, based on a selected measure function, acceptability of the first confidence map; and when the first confidence map is determined to be not acceptable:
receiving second input image data of the scene;
receiving a second input depth map of the scene, the second input depth map having a second input resolution;
generating, using the machine-learning model, a second plurality of kernels for upsampling the second input depth map in order to generate a second output depth map having a second output resolution higher than the second input resolution, the second plurality of kernels being generated based on the second input image data and the second input depth map, wherein each kernel from the second plurality of kernels includes a second plurality of weights; and
applying the second plurality of kernels to the second input depth map to generate the second output depth map, wherein each kernel is applied to a portion of the second input depth map to generate a depth value for a pixel of the second output depth map.

15. The method of claim 14, further comprising, when the first confidence map is determined to be not acceptable, based on the second plurality of weights corresponding to each kernel from the second plurality of kernels, determining a second confidence map for the second output depth map.

16. The method of claim 14, wherein the computing device includes a camera for capturing input image data, and wherein the first input image data is captured by the camera using first camera settings and the second input image data is captured by the camera using second camera settings different from the first camera settings.

17. One or more computer-readable non-transitory storage media embodying software that is operable when executed to:
receive input image data of a scene;
receive an input depth map of the scene, the input depth map having an input resolution;
generate, using a machine-learning model, a plurality of kernels for upsampling the input depth map in order to generate an output depth map having an output resolution higher than the input resolution, the plurality of kernels being generated based on the input image data and the input depth map, wherein each kernel from the plurality of kernels includes a plurality of weights; and
apply the plurality of kernels to the input depth map to generate the output depth map, wherein each kernel is applied to a portion of the input depth map to generate a depth value for a pixel of the output depth map.

18. The media of claim 17, wherein the software is further operable when executed to determine, based on the plurality of weights corresponding to each kernel from the plurality of kernels, a confidence map for the output depth map.

19. A system comprising:
one or more processors; and
one or more computer-readable non-transitory storage media coupled to one or more of the processors and comprising instructions operable when executed by one or more of the processors to cause the system to:
receive input image data of a scene;
receive an input depth map of the scene, the input depth map having an input resolution;
generate, using a machine-learning model, a plurality of kernels for upsampling the input depth map in order to generate an output depth map having an output resolution higher than the input resolution, the plurality of kernels being generated based on the input image data and the input depth map, wherein each kernel from the plurality of kernels includes a plurality of weights; and
apply the plurality of kernels to the input depth map to generate the output depth map, wherein each kernel is applied to a portion of the input depth map to generate a depth value for a pixel of the output depth map.

20. The system of claim 19, wherein the one or more processors are further operable when executing the instructions to cause the system to determine, based on the plurality of weights corresponding to each kernel from the plurality of kernels, a confidence map for the output depth map.
